(19) United States
(12) Patent Application Publication
(10) Pub. No.: US 2005/0149931 A1
(43) Pub. Date: Jul. 7, 2005

(54) Multithread processor architecture for triggered thread switching without any cycle time loss, and without any switching program command

(75) Inventors: Jinan Lin, Ottobrunn (DE); Xiaoning Nie, Neubiberg (DE)

Correspondence Address: Maginot, Moore & Beck, Bank One Center/Tower, Suite 3000, 111 Monument Circle, Indianapolis, IN, 46204, US

(73) Assignee: Infineon Technologies AG, Munchen (DE)

(21) Appl. No.: 10/987,215

(22) Filed: Nov. 12, 2004

(30) Foreign Application Priority Data
Nov. 14, 2003 (DE) 103 53 267.6

(51) Int. Cl. G06F 9/46

(52) U.S. Cl. 718/100

(57) ABSTRACT

A multithread processor according to the inventive architecture is a clocked multithread processor for data processing of threads having a standard processor root unit (1) in which threads can be switched to a different thread T₁ by means a thread switching trigger data field (11), triggered by the thread Tⱼ which is currently to be processed by the standard processor root unit (1), without any clock cycle loss, with each program instruction Iⱼₖ for a thread Tⱼ having a thread switching trigger data field (11) such as this.

### DESCRIPTION

Multithread processor architecture for triggered thread switching without any cycle time loss, and without any switching program command.

The invention relates to an architecture for a multithread processor for triggered switching of threads, which are processed in a standard processor unit pipeline for a multithread processor without any clock cycle loss and without the use of any additional switching program instruction.

According to the inventive architecture, a multithread processor has an instruction fetch unit for fetching program instructions for two or more (N) threads from a program instruction memory, with a thread switching trigger data field being provided within each stored program instruction, an extended instruction register for temporary storage of at least one fetched program instruction and for reading its thread switching trigger data field, a standard processor root unit for execution of the temporarily stored program instructions for two or more (N) threads, with the standard processor root unit being clocked by a clock signal with a predetermined clock cycle time, two or more (N) context memories, which each temporarily store a current context for a thread, a switching detector for reading the thread switching trigger data field, with the switching detector generating a switching trigger signal as a function of the thread switching trigger data field and of a switching program instruction, and with the switching detector blocking the addressed thread for a total of n delayed clock cycles by means of a delay path as a function of the thread switching trigger data field and of a switching program instruction, with the total of n delayed clock cycles corresponding to the value of the thread switching trigger data field or being provided within a switching program instruction, and the switching detector producing a thread reactivation signal for the addressed thread once the total of n delayed clock cycles have elapsed, and a thread monitoring unit, which controls the sequence of the program instructions to be carried out by the standard processor root unit for the various threads as a function of the switching trigger signal and of the thread reactivation signals, such that switching takes place between threads without any clock cycle time.

Now that various methods for avoidance of latency times according to the prior art, such as instruction level paralleling (ILP) methods, such as multiple issue, out of order execution or prefetching have reached their technical limits, the aim of the invention is toleration of latency times while at the same time improving the utilization of the processor. The invention relates to the field of thread level paralleling (TLP), with a thread being processed until it is triggered to switch (switching on trigger). The number of on-board threads is in this case scaleable (course-grained multithreading).

The invention is based on the known fact that latency times for program instructions for threads can be characterized on the basis of their duration and their occurrence. A latency time is characterized by its deterministic or non-deterministic occurrence, and by its deterministic or non-deterministic duration.

Short latency times are essentially of deterministic occurrence. Long latency times are essentially of non-deterministic occurrence.

Long latency times are dealt with in the same way as in conventional course-grained multithreading processes. The aim of the invention is to provide for threads to be switched without any clock cycle loss for latency times with deterministic occurrence.

Embedded processors and their architectures are measured by their power consumption, their throughput, their utilization, their costs and their real-time capability. The principle of pipelining is used in order to increase the throughput and the utilization. The basic idea of pipelining is based on the fact that any desired instructions or commands can be subdivided into processing phases of equal time duration. A pipeline with different processing elements is possible when the processing of an instruction can itself be subdivided into a number of phases with disjunctive process steps which can be carried out successively. The original two instruction execution phases of the Von Neumann model, that is to say instruction fetching and instruction processing, are in this case further subdivided since subdivision into two phases has been found to be too coarse for pipelining. The pipeline variant which is essentially used for RISC processes contains four phases for instruction processing, specifically instruction fetching, instruction coding/operand fetching, instruction execution and write-back.

A thread T denotes a monitoring thread for a code, a source code or a program, with data relationships existing within a thread T and weak data relationships existing between different threads T (as described in Chapter 3 of T. Bayerlein, O. Hagenbruch: “Taschenbuch Mikroprozessortechnik” [Microprocessor technology handbook], 2nd Au signal elements, Fachbuchverlag Leipzig in the Karl Hanser Verlag Munich, Vienna, ISBN 3-446-21686-3).

One characteristic of a process is that a process always accesses its own memory area. A process comprises two or more threads. A thread is accordingly a program part of a process. A context of a thread is the processor state of a processor which is processing this thread or instructions for this thread. The context of a thread is accordingly defined as a temporary processor state during the processing of that thread by this processor. The context is held by the hardware of the processor, specifically the program counting register PZR or program counter PC, the register file or context memory K and the status register SR associated therewith.

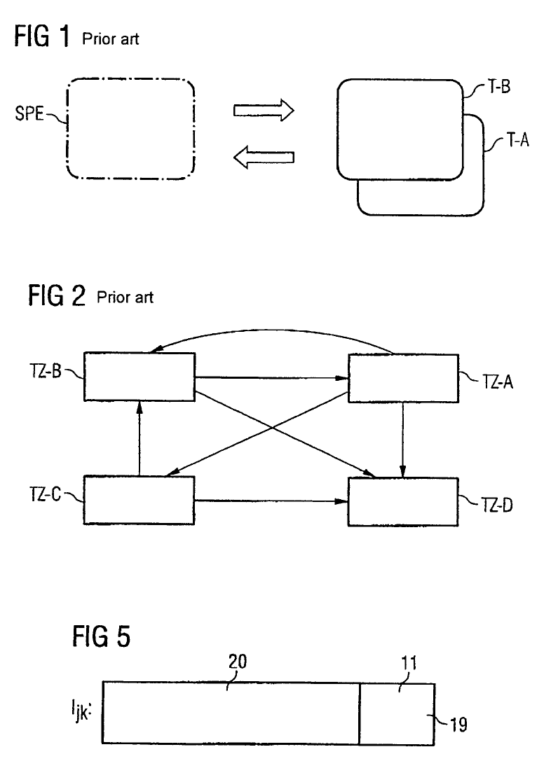

FIG. 1 shows, schematically, a conventional multithread processor MT, in which a standard processor unit SPE processes two or more threads T or monitoring threads, lightweight tasks, separate program codes, common data areas. A thread T denotes a monitoring thread for a code, a source code or a program, with data relationships existing within a thread T and weak data relationships existing between different threads T (as described in Chapter 3 of T. Bayerlein, O. Hagenbruch: “Taschenbuch Mikroprozessortechnik” [Microprocessor technology handbook], 2nd Au signal elements, Fachbuchverlag Leipzig in the Karl Hanser Verlag Munich, Vienna, ISBN 3-446-21686-3). In FIG. 1, without any restriction to generality, the threads T-A, T-B represent any desired number N of threads and are hard-wired within a multithread processor MT with the standard processor root unit SPE, with more efficient switching being ensured between individual threads T. This reduces the blocking probability P_{MT} of a multithread processor MT in comparison to the blocking probability P_{VN} of a Von Neumann machine with a constant thread blocking probability P_{T}, since inefficient waits by the processor caused by result operations from the memory are minimized.

FIG. 2 shows a transition diagram which indicates how a conventional multithread processor switches a thread T between the thread states, specifically a first thread state “being executed” TZ-A, a second thread state “ready to compute” TZ-B, a third thread state “waiting” TZ-C and a fourth thread state “sleeping” TZ-D. In one specific clock cycle, a thread T is in one, and only one, thread state. The possible transitions from one thread state to another thread state will be described in the following text.

First of all, the individual states will be explained. The first thread state “being executed” TZ-A means that the program instructions for this thread Tⱼ are fetched by the instruction fetch unit BHE from a program instruction memory PBS. Only one thread Tⱼ which is in the first thread state “being executed” TZ-A exists at any time or in each clock cycle.

The second thread state “ready to compute” TZ-B means that a thread Tⱼ is ready to be switched to the first thread state “being executed” TZ-A which, by way of example, means that no instructions for this thread Tⱼ which is in the second thread state “ready to compute” TZ-B are waiting for external memory accesses.

The third thread state “waiting” TZ-C means that the thread Tⱼ cannot be switched to the first thread state “being executed” TZ-A at that time, for example because it is waiting for external memory accesses or register accesses.

The fourth thread state “sleeping” TZ-D means that the state Tⱼ is not in any of the three thread states mentioned above.

The following transitions from one thread state to another thread state are possible.

The transition from the first thread state “being executed” TZ-A to the second thread state “ready to compute” TZ-B for the thread Tⱼ:

The transition of the thread Tⱼ from the first thread state “being executed” TZ-A to the second thread state “ready to compute” TZ-B takes place when an explicit start instruction is carried out for another thread T₁, an external interrupt sets the thread Tⱼ to the thread state “ready to compute” TZ-B, or when a timeout occurs for the thread Tⱼ.

The transition from the first thread state “being executed” TZ-A to the fourth thread state “sleeping” TZ-D for the thread Tⱼ:

This transition takes place when a terminating program instruction occurs for the thread Tⱼ.

The transition from the first thread state “being executed” TZ-A to the third thread state “waiting” TZ-C for the thread Tⱼ:

This transition occurs as a result of a switching trigger during a latency time or on the basis of synchronization of the thread Tⱼ to another thread T₁.

The transition from the second thread state “ready to compute” TZ-B to the first thread state “being executed” TZ-A for the thread Tⱼ:

This transition takes place when the thread Tⱼ is selected by an external control program which is managing the switching trigger signals.

The transition from the second thread state “ready to compute” TZ-B to the third thread state “waiting” TZ-C for the thread Tⱼ:

This transition takes place when the thread Tⱼ is ended by an exception or a program instruction.

The transition from the third thread state “waiting” TZ-C to the second thread state “ready to compute” TZ-B:

This transition takes place as a consequence of a thread reactivation signal TRS or of an event control signal.

The transition from the third thread state “waiting” TZ-C to the fourth thread state “sleeping” TZ-D for the thread Tⱼ:

This transition takes place when the thread Tⱼ is ended by an exception or a program instruction.

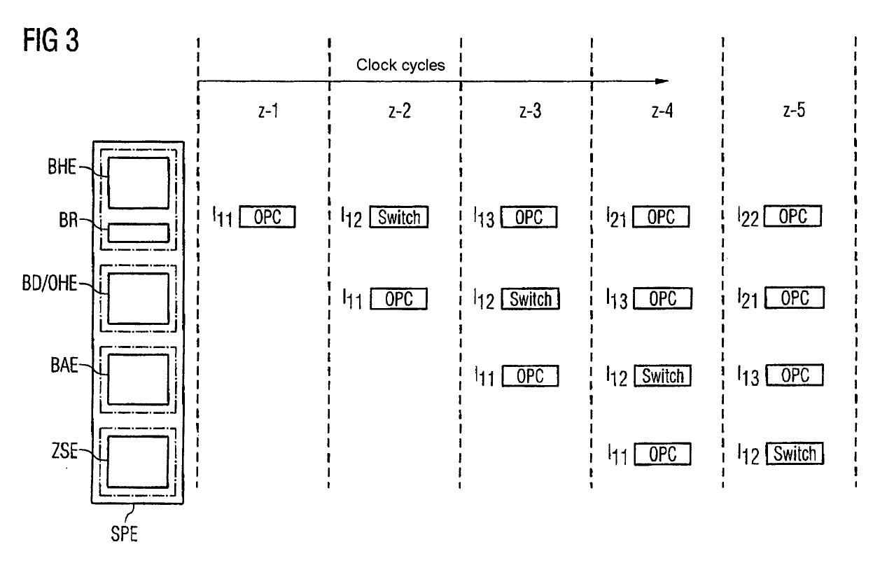

FIG. 3 shows the four phases of instruction processing in a standard processor unit SPE in a multithread processor, with the instructions or program commands being loaded from the instruction memory to an instruction register BR for the standard processor unit SPE in the first phase, which is processed in an instruction fetch unit BHE.

The second instruction phase, which is processed in an instruction decoding/operand fetch unit BD/OHE, comprises two process steps which are independent of data, specifically instruction decoding and the fetching of operands. The data which has been coded using the instruction code is decoded in a first data processing operation in the instruction decoding step. During this process, as is known, the operation rule (Opcode), the number of operands to be loaded, the type of addressing and further additional signals are determined, which essentially control the subsequent instruction execution phases. In the operand fetching process unit, all of the operands which are required for the subsequent instruction execution are loaded from the registers (not shown) for the processor.

In the third instruction phase, which is processed in an instruction execution unit BAE, the computation operations and the operation rules (Opcode) are executed in accordance with the decoded instructions. The operation itself as well as the circuit parts and processor registers used in the process essentially depend on the nature of the instruction to be processed.

As is known, the results of the operations, including so-called additional signals, a status signal element or signal element, are stored in the appropriate registers or memories (not shown) in the fourth and final phase, which is processed in a write-back unit. This phase completes the processing of a machine instruction or machine command.

Furthermore, FIG. 3 shows how a standard processor unit SPE for a conventional multithread processor MT switches, by way of example, from a thread T₁ to another thread T₂. In the illustrated example, the instructions or program commands I₁₁, I₁₂ and I₁₃ for the thread T₁ and the instructions I₂₁, I₂₂ for the thread T₂ are transferred from a program instruction memory PBS (not shown) to the pipeline for the standard processor unit SPE. The program instruction I₁₁, for the thread T₁ is temporarily stored in the instruction register BR by means of the instruction fetch unit BHE in the clock cycle z-1.

The program instruction I₁₁, for the thread T₁, is processed by the instruction decoding/operand fetch unit BD/OHE in the clock cycle z-2, while the instruction fetch unit BHE temporarily stores the instruction I₁₂ in the instruction register BR.

In the clock cycle z-3, the instruction execution unit BAE processes the instruction I₁₁, the instruction decoding/operand fetch unit BD/OHE decodes the instruction I₁₂ and detects that the program instruction I₁₂ is a switching instruction (switch instruction). The switching instruction results in no instructions for the thread T₁ being fetched in the subsequent clock cycles, but in the thread T₁ being switched from the first thread state “being executed” TZ-A to the second thread state “ready to compute” TZ-B, or to the third thread state “waiting” TZ-C. Furthermore, the switching instruction results in instructions for another thread T₂ being fetched in the subsequent clock cycles. In the clock cycle z-3, an instruction I₁₃ for the thread T₁ is also temporarily stored by the instruction fetch unit BHE in the instruction register BR. The instruction 113 for the thread T₁ fills the remaining pipeline stages in the subsequent clock cycles, but is no longer processed by them, since the thread T₂, is in the thread state “waiting” TZ-C. In the clock cycle z-4, the first instruction I₂₁ for the thread T₂ is temporarily stored by the instruction fetch unit BHE in the instruction register BR. Instructions for the thread T₂ are processed in the subsequent clock cycles, provided that this thread T₂ is not switched by means of a switching instruction.

This example illustrates that the use of a switching program instruction for switching between two threads Tⱼ and T₁ within a pipeline for a standard processor unit SPE for a multithread processor MT results in failure to use at least two clock cycles. In the illustrated example, no instructions or program instructions are carried out for the thread T₁ in the instructions I₁₃ and I₁₂, and the utilization of the processor is reduced.

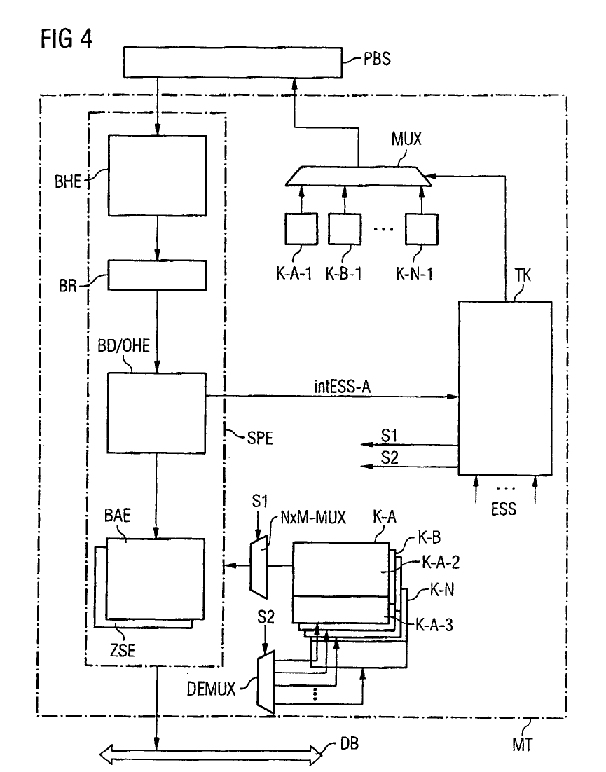

FIG. 4 shows a conventional multithread processor MT for data processing of program instructions by two or more threads, with the multithread processor MT reading program instructions from a program instruction memory PBS, which processes program instructions within a standard processor unit SPE and stores the results of the processing of the program instructions in the N context memories K, which are hard-wired to the standard processor unit SPE, or passes them on by means of a data bus DB. When a store instruction occurs, the data is passed on via the data bus DB to an external memory, where it is externally stored. The multithread processor MT has a standard processor unit SPE for processing program instructions, N different context memories K for temporary storage of the memory contents of the threads, and a thread monitoring unit TK.

The function of the thread monitoring unit TK when a thread which is in the first thread state “being executed” TZ-A is blocked is to switch this thread from the first thread state “being executed” TZ-A to the third thread state “waiting” TZ-C, and to quickly switch another thread which is in the second thread state “ready to compute” TZ-B to the first thread state “being executed” TZ-A, so that instructions are produced for the thread which is now in the first thread state “being executed” TZ-A.

Once each pipeline stage for the standard processor unit SPE can process a program instruction for another thread, the thread monitoring unit TK has the function of controlling the N×M multiplexer N×M-MUX such that each pipeline stage is provided with the appropriate operands for that particular thread. A demultiplexer DEMUX has the function of writing operation results from program instructions for a specific thread back to the context memory K for that particular thread.

The thread monitoring unit TK controls the N×M multiplexer N×M-MUX by means of the control signal S1, and controls the demultiplexer DEMUX by means of the control signal S2.

The standard processor unit SPE preferably has an instruction fetch unit BHE, an instruction register BR, an instruction decoding/operand fetch unit BD/OHE, an instruction execution unit BAE and a write-back unit ZSE, with these units forming a pipeline for program instruction processing within the standard processor unit SPE. When a program instruction which will cause blocking of the pipeline of the standard processor unit SPE is fetched by the instruction fetch unit BHE for the standard processor unit SPE from the program instruction memory PBS and is temporarily stored in an instruction register BR, then this program instruction is decoded by the instruction decoding/operand unit BD/OHE in a subsequent clock cycle. Since this program instruction causes blocking, for example because of a waiting time for an external memory, the instruction decoding/operand fetch unit BD/OHE generates an internal event control signal intESS-A for a switching program instruction. The internal event control signal intESS-A for a switching instruction is transferred to the thread monitoring unit TK. The thread monitoring unit TK uses this internal event control signal intESS-A for a switching instruction to switch the thread Tⱼ which has the program instruction which is causing the blocking of the pipeline for the standard processor unit SPE from the first thread state “being executed” TZ-A to the third thread state “waiting” TZ-C, and switches another thread T₁ which is in the second thread state “ready to compute” TZ-B, to the first thread state “being executed” TZ-A.

The thread monitoring unit TK controls a multiplexer MUX such that addresses of program instructions for the thread T₁ are read from the program counting register K-A of the context memory A for the thread T₁, and these are sent to the program instruction memory PBS, in order to produce program instructions for the thread T₁. These can thus be fetched by the instruction fetch unit BHE for the standard processor unit SPE.

The arrangement according to the prior art, which is illustrated in FIG. 4, shows how, on the basis of a blocking program instruction for a thread Tⱼ, switching takes place from this thread Tⱼ to another thread T₁. The switching process is triggered by an internal event control signal intESS-A for a switching program instruction. The switching process can be initialized, as above, by means of a dedicated switching program instruction from the program instruction memory PBS, or by an external interrupt. Since the internal event control signal intESS-A for a switching instruction is detected and decoded only in a deeper level of the pipeline of the standard processor unit SPE, at least two clock cycles are required according to this example for switching from a thread Tⱼ to another thread T₁. These clock cycles which are required for switching are lost for processing program instructions.

The object of the present invention is thus to provide a multithread processor which switches between two or more threads without any clock cycle loss and without the need for a dedicated switching program instruction.

The idea on which the invention is based essentially comprises switching at an early stage to another thread T₁, which is ready to compute, from a thread Tⱼ which, in m clock cycles, has a program instruction Iⱼₖ which blocks the pipeline for the standard processor root unit and results in a latency time with deterministic occurrence.

A multithread processor according to the inventive architecture is a clocked multithread processor for data processing of threads having a standard processor root unit, in which threads can be switched from the thread Tⱼ which is currently to be processed by the standard processor root unit to another thread T₁, triggered by a thread switching trigger data field, without any clock cycle loss, with each program instruction Iⱼₖ for a thread Tⱼ having a thread switching trigger data field such as this.

The advantages of the arrangement according to the invention are, in particular, that the multithread processor makes use of the blocking time which is caused by a program instruction which is blocking the standard processor root unit, in order to process program instructions for other threads.

Advantageous developments of the multithread process architecture for thread switching without any cycle time loss and without the need to use a switching program instruction are contained in the dependent claims.

According to one preferred development, a thread T is in the first thread state “being executed”, in a second thread state “ready to compute”, in the third thread state “waiting” or in a fourth thread state “sleeping”.

According to a further preferred development, the multithread processor has the following units. An instruction fetch unit for at least one thread T to fetch program instructions Iⱼₖ from the program instruction memory, with each program instruction having a thread switching trigger data field. The thread switching trigger data field indicates whether a thread Tⱼ is being switched from the first thread state “being executed” to the third thread state “waiting”. Furthermore, the thread switching trigger data field indicates the number n of delayed clock cycles for which the thread Tⱼ is held in the third thread state “waiting”.

One advantage of this development is that the thread switching trigger data field provides a simple data format for switching threads within a multithread processor. The thread switching trigger data field is provided in each case in a standard form in a previous program instruction, in order that it can be read at an early stage. The early reading advantageously ensures switching without any clock cycle time loss (zero overhead switching).

According to a further preferred development, the multithread processor has an extended instruction register for temporary storage of at least one fetched program instruction Iⱼₖ.

One advantage of this development according to the invention is that the thread switching trigger data field can simply be read from the extended instruction register, which is located upstream of the pipeline for the standard processor root unit. This allows early switching of threads.

According to a further preferred development, the standard processor root unit is provided for sequential instruction execution of the temporarily stored program instruction. In this case, the standard processor root unit is clocked with a predetermined clock cycle time.

One advantage of this development according to the invention is that the clocking of the standard processor root unit ensures that the multithread processor has a real-time capability.

According to a further preferred development, context memories are provided within the multithread processor N. The N context memories each temporarily store one current context for a thread.

One advantage of this development according to the invention is that the provision of N different contexts within the multithread processor ensures rapid hardware switching between threads.

According to a further preferred development, data which indicates the number n of delayed clock cycles for which the thread Tⱼ is held in the thread state “waiting” is provided within a switching program instruction for a thread Tⱼ. In the situation where n=0, the thread Tⱼ to be processed is switched to the second thread state “ready to compute”.

One advantage of this preferred development is that switching of threads is ensured by means of conventional switching program instructions, as well. According to the invention, data which indicates the number n of delayed clock cycles for which the thread T is held in the thread state “waiting” is provided within a switching program instruction. A specific thread can thus be switched not only by a switching program instruction, but also by a TSTF value greater than 0. The number n of delayed clock cycles is also provided by both the TSTF value and the switching program instruction.

According to a further preferred development, the multithread processor has a switching detector. The switching detector generates a switching trigger signal as a function of the thread switching trigger data field or as a function of an internal event control signal intESS-A for a switching program instruction. The TSTF value for the thread switching trigger data field corresponds to a total of n delayed clock cycles. If a TSTF value for a thread switching trigger data field is not equal to zero, a switching trigger signal is for switching the thread Tⱼ from the first thread state “being executed” to the third thread state “waiting”. The switching detector uses a delay path to generate a thread reactivation signal for the thread Tⱼ once the total of n delayed clock signals have elapsed, and to switch this thread Tⱼ from the third thread state “waiting” to the second thread state “ready to compute”.

One advantage of this development according to the invention is that the provision of a switching detector makes it possible to switch threads which would block the pipeline for the standard processor root unit, at an early stage. Furthermore, the switching detector makes it possible to keep the respective blocking thread in the thread state “waiting” for the appropriate number n of delayed clock cycles.

For a program instruction which results in a latency time with deterministic occurrence, the thread switching trigger data field for a previous instruction is set such that the TSTF value corresponds to the latency time duration to be expected.

According to a further preferred development, the multithread processor has a thread monitoring unit which controls the sequence of the program instructions to be processed by the standard processor root unit for the various threads as a function of the switching trigger signal and of the thread reactivation signals, such that switching takes place between threads without any clock cycle loss. The switching trigger signal for the thread Tⱼ is used to switch the thread Tⱼ from the first thread state “being executed” to the third thread state “waiting”. At the same time, the switching trigger signal switches another thread T₁ from the second thread state “ready to compute” to the first thread state “being executed”. The thread reactivation signal for the thread Tⱼ is used to switch the thread Tⱼ from the third thread state “waiting” to the second thread state “ready to compute”.

According to a further preferred development, the thread monitoring unit controls an N×1 multiplexer such that program instructions for a thread which is in the first thread state “being executed” are read from the program instruction memory and are processed by the standard processor root unit.

According to a further preferred development, the thread monitoring unit controls an N×1 multiplexer such that program instructions for a thread Tⱼ which is in the second thread state “ready to compute” are read from the program instruction memory and are processed by the standard processor root unit when no other thread T₁ is in the first thread state “being executed”. This means that the thread Tⱼ is switched to the first thread state “being executed”.

According to a further preferred development, the thread monitoring unit controls the N×1 multiplexer such that program instructions for a thread Tⱼ which is in the third thread state “waiting” are not read from the program instruction memory or are processed by the standard processor root unit until the thread monitoring unit receives the thread reactivation signal for the thread Tⱼ. Subsequently, the same thread Tⱼ is switched to the second thread state “ready to compute”, when no other thread T₁ is in the first thread state “being executed”, the thread Tⱼ is switched to the first thread state “being executed”.

According to a further preferred development, the thread monitoring unit controls the N>1 multiplexer such that no program instructions for a thread Tⱼ which is in the fourth thread state “sleeping” are read from the program instruction memory or are processed by the standard processor root unit.

According to a further preferred development, the switching detector has a delay circuit for N threads and a trigger circuit for the switching trigger signal.

According to a further preferred development, the delay circuit for N threads has a delay path for each of the N threads. A delay path for the corresponding thread delays this thread by the number n of delayed clock cycles, with the number n of delayed clock cycles corresponding to the TSTF value of the corresponding thread switching trigger data field. The appropriate thread Tⱼ is held by means of the delay path 14 in the third thread state “waiting” for the total of n delayed clock cycles.

According to a further preferred development, the thread switching trigger data field for a specific program instruction is included in a program instruction which occurred a number m of clock cycles previously, with this forward shift of the thread switching trigger data field being produced, for example, by means of an assembler.

One advantage of this preferred development is that an early detection of switching data is sent by means of the thread switching trigger data field via a program instruction to the switching detector, with this program instruction still being in the program instruction memory.

According to a further preferred development, the thread switching trigger data field has a program instruction format to which two or more control bits have been added. The control bits form a TSTF value.

According to a further preferred development, the switching trigger signal is generated by a TSTF value greater than zero. The thread Tⱼ is switched from the first thread state “being executed” to the third thread state “waiting” by means of the thread switching trigger data field in a program instruction for the thread Tⱼ.

According to a further preferred development, the TSTF value for the thread switching trigger data field for the program instruction Iⱼₖ for the thread Tⱼ indicates the number n of delayed clock cycles for which the thread Tⱼ will be set to the third thread state “waiting”, with the TSTF value indicating the length of the delay path.

According to a further preferred development, the thread Tⱼ is switched from the third thread state “waiting” to the second thread state “ready to compute” by means of the thread reactivation signal for the thread Tⱼ once the number n of delayed clock cycles have elapsed.

According to a further preferred development, the standard processor root unit has an instruction decoder for decoding a program instruction, an instruction execution unit for execution of the decoded program instruction, and a write-back unit for writing back operation results.

According to a further preferred development, each context memory has a program counting register for temporary storage of a program counter, a register bank for temporary storage of operands, and a status register for temporary storage of status signal elements.

According to a further preferred development of the invention, the number N of context memories is predetermined.

According to a further preferred development, the memory contents of the program counting register, of the register bank and of the status register form the context of the corresponding thread.

According to one preferred development, the instruction fetch unit is connected to the program instruction memory in order to read program instructions. In this case, the program instructions which are read from the program instruction memory are addressed by the program counting registers for the context memories.

According to a further preferred development, the standard processor root unit is connected to a data bus in order to pass the processed data via this data bus to a data memory.

According to a further preferred development, the standard processor root unit processes those program instructions which are passed to it from the thread monitoring unit sequentially using a pipeline method.

According to a further preferred development, the standard processor root unit processes a program instruction to be processed, within a predetermined number of clock cycles.

According to a further preferred development, the thread monitoring unit receives event control signals.

According to a further preferred development, the received event control signals which are received from the thread monitoring unit comprise internal event control signals and external event control signals.

According to a further preferred development, the internal event control signals are produced by the instruction decoding unit for the standard processor root unit.

According to a further preferred development, the internal event control signals comprise, inter alia, an internal event control signal intESS-A for a switching program instruction, which is generated by the standard processor root unit.

According to a further preferred development, the switching trigger signal is generated by the internal event control signal intESS-A for a switching program instruction. The signal intESS-A includes a signal element intESS-A-n, which includes the number n of delayed clock cycles. The switching trigger signal for a thread Tⱼ thus switches that thread Tⱼ from the first thread state “being executed” or from the second thread state “ready to compute” to the third thread state “waiting”.

According to a further preferred development, a delay path is produced for the thread Tⱼ by means of the internal event control signal for a switching program instruction. Once the total of n delayed clock signals for the delay path have elapsed, the thread reactivation signal for the thread Tⱼ switches that thread Tⱼ from the third thread state “waiting” to the second thread state “ready to compute”.

According to a further preferred development, an OR gate, which logically links the internal event control signal for a switching program instruction to the TSTF value for the thread switching trigger data field, forms the trigger circuit for a switching trigger signal.

According to a further preferred development, the delay circuit is driven by a Iⱼₖ demultiplexer, which receives the TSTF value of the thread switching trigger data field on the input side, and by a 1×N demultiplexer which receives the internal event control signal for a switching instruction on the input side.

According to a further preferred development, a thread identification signal which addresses the program instruction to be processed is produced by the thread monitoring unit.

According to a further preferred development, the thread identification signal synchronizes the two 1×N demultiplexers, in order that they switch at the correct time.

According to a further preferred development, the external event control signals are produced by external assemblies.

One advantage of this development is that the provision of the event control signals allows thread switching to be triggered both internally and by external assemblies.

According to a further preferred development, the standard processor root unit is a part of a DSP processor, of a protocol processor or of a universal processor.

According to a further preferred development, the instruction execution unit for the standard processor root unit may contain an arithmetic logic unit (ALU) and/or an address generator unit (AGU).

According to a further preferred development, the thread monitoring unit drives switching networks as a function of the internal and external event control signals.

Exemplary embodiments of the invention are illustrated in the drawings and will be explained in more detail in the following description. The same reference symbols in the figures denote identical or functionally identical elements.

In the figures:

FIG. 1 shows a schematic illustration of a conventional multithread processor according to the prior art

FIG. 2 shows a transition diagram for all the potential thread states of a thread according to the prior art

FIG. 3 shows a flowchart for processing program instructions by two threads by means of a pipeline for a standard processor unit in a conventional multithread processor, with a switching program instruction being used to switch between the two threads.

FIG. 4 shows a block diagram of a conventional multithread processor according to the prior art

FIG. 5 shows an extension, according to the invention, of a conventional program instruction format by the addition of a thread switching trigger data field

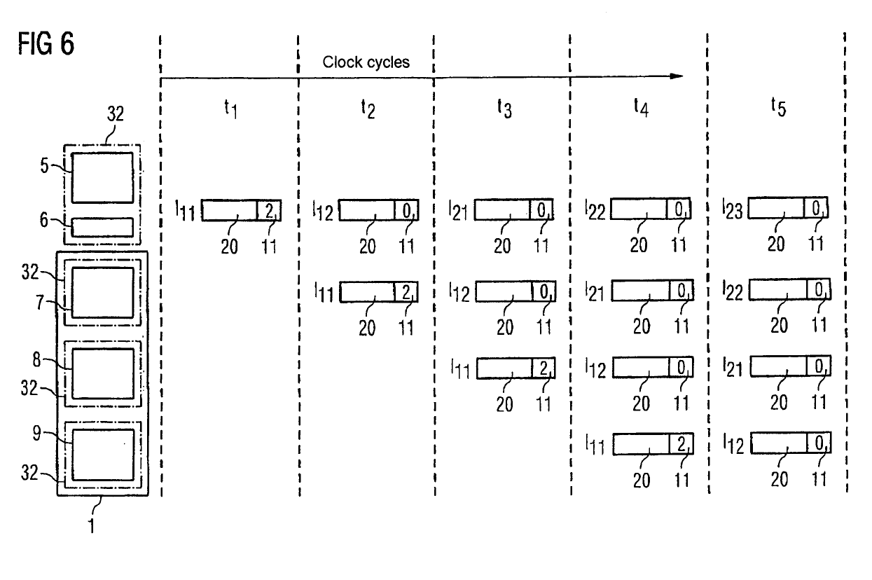

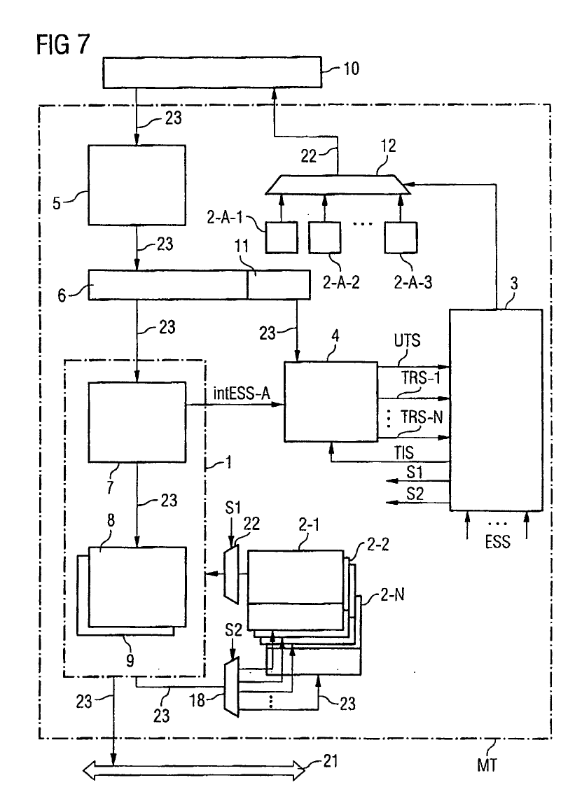

FIG. 6 shows a flowchart for processing, according to the invention, program instructions from two threads by means of a pipeline for a standard processor root unit for a multithread processor, with switching taking place between the two threads without any switching program instruction.

FIG. 7 shows a block diagram of a multithread processor according to the invention with a switching detector, and

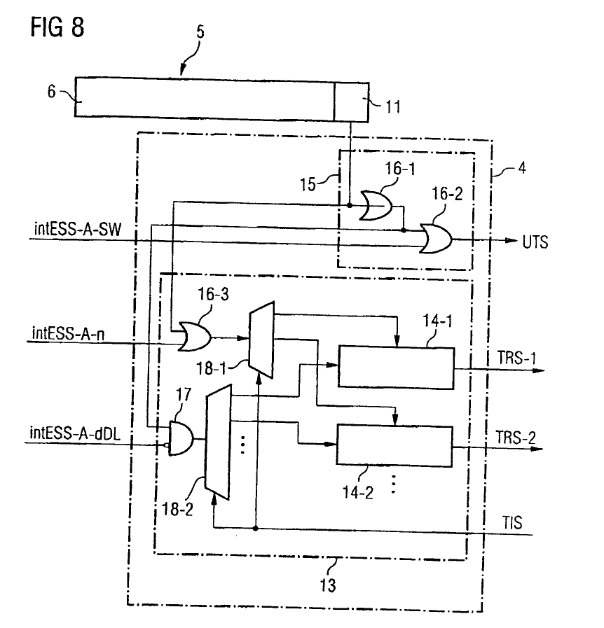

FIG. 8 shows a detailed block diagram of the switching detector according to the invention.

The same reference symbols in the figures denote identical or functionally identical elements.

Although the present invention is described in the following text with reference to processors or microprocessors and their architectures, it is not restricted to them but can be used in many ways.

FIG. 5 shows a program instruction format according to the invention, which is used for a multithread processor according to the invention. The program instruction format according to the invention is an extension to a conventional program instruction format 20 by the addition of a thread switching trigger data field 11. Two or more control bits, which form a TSTF value 19, are provided in the thread switching trigger data field 11. The program instruction Iⱼₖ illustrated in FIG. 5 is the k-th program instruction for the thread Tⱼ.

FIG. 6 shows a flowchart for processing, according to the invention, program instructions for two threads by means of a pipeline for a standard processor root unit 1 for a multithread processor MT, with switching taking place between the two threads without a switching program instruction. The standard processor root unit 1 has an instruction decoding/operand fetch unit 7, an instruction execution unit 8 and a write-back unit 9. The pipeline for the multithread processor according to the invention is formed by the instruction decoding/operand fetch unit 7, the instruction execution unit 8 for the write-back unit 9 for the standard processor unit 1, as well as an instruction fetch unit 5 and an instruction register 6. A dotted boundary around a pipeline step or pipeline steps indicates that one and only one clock cycle 32 is required for this pipeline step or these pipeline steps.

The program instruction I₁₁ for the thread T₁ is fetched by the instruction fetch unit 5 from the program instruction memory 10 (not shown) in the clock cycle t₁, and is temporarily stored in the instruction register 6. The program instruction I₁₁, the first program instruction for the thread T₁, has a thread switching trigger data field 11 in addition to its conventional program instruction format 20, indicating whether the program instruction I₁₂, which will be fetched by the instruction fetch unit 5 from the program instruction memory 10 in the clock cycle t₂, will block the pipeline for the standard processor root unit 1, and for how many clock cycles this program instruction will block the pipeline for the standard processor unit 1.

If the thread switching trigger data field 11 fetched by means of the program instruction I₁₁ is zero, then the program instruction I₁₂ fetched in the clock cycle t₂ will not block the pipeline for the standard processor root unit. If the thread switching trigger data field 11 is greater than zero, the TSTF value 19 for the thread switching trigger data field 11 indicates the number of clock cycles for which this gram instruction I₁₂ will block the pipeline for the standard processor unit 1. Since, in the present example, the TSTF value 19 fetched by means of the program instruction I₁₁ for the thread switching trigger data field 11 is not equal to zero, the next program instruction for the thread T₁, specifically the program instruction I₁₂ would block the pipeline if no thread switching were carried out.

In the clock cycle t₂, the instruction decoding/operand fetch unit 7 decodes the program instruction I₁₁ for the thread T₁, and the instruction fetch unit 5 fetches the program instruction I₁₂ for the thread T₁ from the program instruction memory 10 and temporarily stores this in the instruction register 6. At the same time, the TSTF value 19 fetched with the program instruction I₁₁ (according to the example, the TSTF value 19 is equal to 2) for the thread switching trigger data field 11 is identified by the switching detector 4, which generates the switching trigger signal UTS and transfers the switching trigger signal UTS to the thread monitoring unit 3, which switches the thread T₁ from the first thread state “being executed” (25) to the third thread state “waiting” (27), and at the same time switches another thread T₂ from the second thread state “ready to compute” (26) to the first thread state “being executed” (25). I₁₂ is thus the last program instruction fetched for the thread T₁. Since the TSTF value 19 fetched with the program instruction I₁₁ for the thread switching trigger data field 11 is equal to 2, no further program instruction is fetched by the thread T₁ for two clock cycles.

In the clock cycle t₃, the instruction execution unit 8 for the standard processor root unit 1 processes the program instruction I₁₁ for the thread T₁, the instruction decoding/operand fetch unit 7 for the standard processor root unit 1 decodes the program instruction I₁₂ for the thread T₁, and the instruction fetch unit 5 fetches a program instruction I₂₁ for the thread T₂, since the “being executed” thread has been switched from threads T₁ to threads T₂ in the clock cycle t₂.

In the subsequent clock cycles t₄, t₅, etc., the program instructions for the thread T₁, specifically the program instruction I₁₁ and the program instruction I₁₂, are processed further by the pipeline for the standard processor root unit 1. However, program instructions for the thread T₂ are fetched by the instruction fetch unit 5 only until this thread T₂ is switched on the basis of a TSTF value 19 of a thread switching trigger data field 11 for a program instruction which is not equal to zero. In the clock cycle t₅, threads T₁ are switched from the third thread state “waiting” (27) to the second thread state “ready to compute” (26), that is to say threads T₁ can be executed at any time later again, as soon as the thread T₂ has been switched from the first thread state “being executed” (25) to the third thread state “waiting” (27).

The arrangement according to the invention illustrated in FIG. 6 shows that switching takes place between the threads T₁ and T₂ without the loss of a clock cycle and without the use of a switching program instruction.

FIG. 7 shows a block diagram of a multithread processor according to the invention having a switching detector. The multithread processor MT is connected to a program instruction memory 10 and to a data bus 21.

The multithread processor MT according to the invention essentially has a standard processor root unit 1, N context memories 2, a thread monitoring unit 3, a switching detector 4, an instruction fetch unit 5, an instruction register 6 and an N>1 multiplexer 12.

The standard processor root unit 1 is organized on the basis of the pipeline principle according to Von Neumann. The pipeline for the standard processor root unit 1 has an instruction decoder 7, an instruction execution unit 8 and a write-back unit 9.

Each of the N context memories 2 has a program counting register 2-A, a register bank 2-B and a status register 2-C.

As is known, operands and status signal elements are provided by means of the N×3 multiplexer on a clock-cycle sensitive basis to the pipeline stages of the standard processor root unit via the register banks 2-B and the status registers 2-C for the context memories 2.

After the pipeline stage for the instruction processing unit 8, the write-back unit 9 writes the operation results and status signal elements via a Iⱼₖ demultiplexer 18 to the appropriate context memory 2, and/or to the appropriate register bank 2-B and/or to the appropriate status register 2-C. Furthermore, the write-back unit 9 provides the calculated operation results and status signal elements to external memories via a data bus 21.

The program counting registers 2-A for the context memories 2 address the program instructions to be read. The thread monitoring unit 3 uses the N>1 multiplexer 12 to control which program instructions are read for the thread to be processed. The N>1 multiplexer 12 reads the addresses of the program instructions from the program counting register 2-i relating to the thread Tᵢ to be processed. The addresses of the program instructions to be read are transmitted from the N×1 multiplexer 12 to the program instruction memory 10 via an address line 22. The instruction fetch unit 5 reads the addressed program instructions to be read from the program instruction memory 10, and temporarily stores them in an instruction register 6.

The instruction decoder 7 in each case fetches one program instruction from the instruction register 6, and decodes it. If the decoded program instruction is a switching program instruction, the instruction decoder 7 generates an internal event control signal intESS-A for a and sends this signal to the switching detector 4. The program instruction is processed in the subsequent pipeline stages in a corresponding manner to that in the prior art.

The switching detector 4 reads the thread switching trigger data field 11 for a program instruction from the instruction register 6. If the TSTF value 19 for the thread switching trigger data field 11 that is being read is not equal to zero, and if an internal event control signal intESS-A exists for a switching program instruction, the switching detector 4 generates a switching trigger signal UTS, and sends this to the thread monitoring unit 3. Furthermore, the switching detector 4 sets the thread Tⱼ (which has been addressed by the thread switching trigger data field 11 or by an internal event control signal intESS-A for a switching program instruction) to the thread state “waiting”. Once the number n of delayed clock signals indicated by the TSTF value 19 or by a switching program instruction (the signal element intESS-A-n) have elapsed, the switching detector 4 generates a thread reactivation signal TRS for the appropriate thread Tⱼ, and sends this to the thread monitoring unit 3.

The thread monitoring unit 3 generates a control signal S1 for controlling the N×3 multiplexer 22, and generates a control signal S2 in order to control the 1×N demultiplexer 18.

The thread monitoring unit 3 receives the switching trigger signals UTS as well as the thread reactivation signals TRS together with event control signals ESS, and uses them to generate an optimized sequence of threads to be processed. The multiplexer 12 is driven by means of the optimized sequence of threads to be processed.

FIG. 8 shows the design of the switching detector 4, in detail. The switching detector 4 essentially has a delay circuit 13 and a trigger circuit 15.

The trigger circuit 15 carries out a logic operation by means of two logic OR operations 16-1 and 16-2.

The logic OR operation 16-1 receives the TSTF value 19 for the thread switching trigger data field 11 on the input side. If the TSTF value 19 for the thread switching trigger data field 11 is greater than zero, then the output of the logic OR operation 16-1 is set to one.

The second logic OR operation 16-2 in the trigger circuit 15 receives the output from the logic OR operation 16-1 and a switch signal element intESS-A-SW from an internal event control signal intESS-A for a switching program instruction on the input side. If either the output of the logic OR operation 16-1 or the switch signal element intESS-A-SW for an internal event control signal intESS-A for a switching program instruction is one, then the output of the logic OR operation 16-2 which at the same time forms the output of the trigger circuit 15 is set to one. The output of the trigger circuit 15 forms the switching trigger signal UTS. As illustrated in FIG. 7, the switching trigger signal UTS is received from the thread monitoring unit 3 (not shown).

The delay circuit 13 essentially has N delay paths 14 for N threads.

A logic OR operation 16-3 links, on the input side, the TSTF value 19 to an n-signal element of an internal event control signal for a switching program instruction IntESS-A-n in order to indicate the number n of delayed clock cycles 30. The output of the logic OR operation 16-3 drives a Iⱼₖ demultiplexer 18-1. The 1×N demultiplexer 18-1 has the function of producing the correct number n of delayed clock cycles 30 for the corresponding delay path 14.

In addition to the signals intESS-A-SW and intESS-A-n, the event control signal intESS-A for a switching instruction contains a disable delay line signal element intESS-A-dDL. The signal intESS-A-dDL (dDL=disable delay line) has the function of switching off the delay path 14-j for the corresponding thread Tⱼ for latency times with a non-deterministic duration. The thread Tⱼ can thus not be reactivated by the corresponding delay path 14-j, that is to say it cannot be switched from the third thread state “waiting” 27 to the second thread state “ready to compute” 26. For latency times with a non-deterministic duration and deterministic occurrence, this switching is controlled by an event control signal ESS.

The logic AND operation 17 rounds off the negation of the signal intESS-A-dDL and the output of the logic OR operation 16-1.

The output of the logic AND operation 17 drives the 1×N demultiplexer 18-2, which triggers the N delay paths 14.

Both the 1×N demultiplexer 18-1 and the 1×N demultiplexer 18-2 are synchronized by a thread identification signal TIS, which is produced by the thread monitoring unit 3 (not shown). The synchronization is necessary in order that the corresponding delay circuit 14-j for the corresponding thread Tⱼ switches to the correct clock cycle for this thread Tⱼ.

A delay path 14-j delays a thread Tⱼ since, for this thread Tⱼ, the delay path 14-j was driven either by the TSTF value 19 of a thread switching trigger data field 11 or by an internal event control signal intESS-A for a switching program instruction. The thread Tⱼ is delayed for the appropriate number n of delayed clock cycles 30, and the switching detector 4 produces a thread reactivation signal TIS-j once the number n of delayed clock cycles 30 has elapsed. The thread reactivation signal TRS-j is received and processed further by the thread monitoring unit 3 (not shown).

Although the present invention has been described above with reference to preferred exemplary embodiments, it is not restricted to them but can be modified in many ways.

1-52. (canceled)

53. A multithread processor for data processing of a plurality of threads, the multithread processor comprising:
a standard processor root unit operable to process a thread Tⱼ, each program instruction Iⱼₖ for the thread Tⱼ including an associated thread switching trigger data field;
a circuit operable to cause the standard processor root unit to switch, without any clock cycle loss, to process a different thread T₁ responsive to information in a first thread switching trigger data field obtained from the a particular program instruction for the thread Tⱼ.

54. The multithread processor according to claim 53, wherein each thread is in one of a set of states, the set of states including a first state in which the thread is being executed, a second state in which the thread is ready to compute, a third state in which the thread is waiting, and a fourth state in which the thread is sleeping.

55. The multithread processor according to claim 54, further comprising an instruction fetch unit configured to fetch program instructions for the thread Tⱼ from a program instruction memory, and wherein for each fetched program instruction, the associated thread switching trigger data field indicates whether a thread Tⱼ is to be switched from the first state to the third state, and further indicates the number n of delayed clock cycles for which the thread Tⱼ is to be held in the third state if the thread Tⱼ is to be switched from the first state to the third state.

56. The multithread processor according to claim 53, further comprising an extended instruction register operable to temporarily store at least one fetched program instruction.

57. The multithread processor according to claim 56, wherein the standard processor root unit is operable to perform sequential instruction execution of the temporarily stored at least one fetched program instruction, and wherein the standard processor root unit is clocked by a clock signal having a predetermined clock cycle time.

58. The multithread processor according to claim 53, further comprising at least one context memory, each context memory configured to temporarily store a current context for a corresponding thread.

59. The multithread processor according to claim 53, wherein at least one program instruction includes data which indicates a number n of delayed clock cycles for which the thread Tⱼ will be held in a waiting state.

60. A multithread processor for data processing of a plurality of threads, each thread being in one of a set of states, the set of states including a first state in which the thread is being executed, a second state in which the thread is ready to compute, a third state in which the thread is waiting, and a fourth state in which the thread is sleeping, the multithread processor comprising:
a standard processor unit operable to process a thread Tⱼ;
a switching detector to generate a switching trigger signal responsive to a thread switching trigger data field obtained from the thread Tⱼ, the switching trigger signal operable to cause the standard processor unit to switch to process a different thread T₁, the switching detector further operable to cause the thread Tⱼ to switch from the first state to the third state for n delayed clock cycles based on the thread switching trigger data field, the switching detector further operable to generate a thread reactivation signal after passage of the n clock cycles;
an instruction fetch unit configured to fetch program instructions for at least the thread Tⱼ from a program instruction memory, each fetched program instruction having an associated thread switching trigger data field.

61. The multithread processor according to claim 60, further comprising a thread monitoring unit configured to control a sequence of the program instructions to be processed by the standard processor unit for the various threads as a function of the switching trigger signal and of the thread reactivation signal, wherein, responsive to the switching trigger signal, the thread monitoring unit is operable to cause the thread Tⱼ to switch from the first state to the third state, and to cause the thread T₁ to switch from the second state to the first state, and responsive to the thread reactivation signal, the thread monitoring unit is operable to cause the thread Tⱼ to switch from the third state to the second state.

62. The multithread processor according to claim 61, further comprising an N×1 multiplexer operably coupled to cause program instructions of a specific thread to be provided to the instruction fetch unit when the specific thread is in the first state, the N×1 multiplexer being controlled by the thread monitoring unit.

63. The multithread processor according to claim 61, further comprising an N×1 multiplexer operable to cause, under the control of the thread monitoring unit, program instructions for a specific thread which is in the second state to be provided to the instruction fetch unit when the standard processor unit becomes available to execute a thread.

64. A multithread processor according to claim 61, further comprising an N×1 multiplexer operable to cause, under the control of the thread monitoring unit, program instructions for a specific thread to be provided to the instruction fetch unit when the standard processor unit is available to execute a thread only if the specific thread is in the second state.

65. The multithread processor according to claim 60, wherein the switching detector includes a delay circuit corresponding to the plurality of threads, and a trigger circuit operable to generate the switching trigger signal.

66. The multithread processor according to claim 65, wherein the delay circuit further comprises a delay path for each of the plurality of threads, each delay path configured to hold the corresponding thread in the third state for a specified number of clock cycles.

67. The multithread processor according to claim 55, wherein the thread switching trigger data field for a specific program instruction is included in a program instruction which occurred a number m of clock cycles previously.

68. The multithread processor according to claim 53, wherein the thread switching trigger data field includes two or more control bits in addition to a conventional program instruction format.

69. The multithread processor according to claim 60, wherein:
the thread switching trigger data field includes two or more control bits forming a first value, and
the switching trigger signal is generated when the first value is greater than zero, the switching trigger signal causing the thread Tⱼ to switch from the first state the third state.

70. The multithread processor according to claim 66, wherein the thread switching trigger data field includes two or more control bits forming a first value, the first value defining a length of one of the delay paths.

71. The multithread processor according to claim 60, wherein the thread reactivation signal is further operable to cause the thread Tⱼ to switch from the third state to the second state after the n clock cycles.

72. The multithread processor according to claim 53, wherein the standard processor unit includes an instruction decoder configured to decode a program instruction, an instruction execution unit configured to execute the decoded program instruction, and a write-back unit configured to write back operation results.

73. The multithread processor according to claim 58, wherein the at least one context memory includes a program counting register configured to store a program counter, a register bank configured to store operands, and a status register configured to store status signal elements.

74. The multithread processor according to claim 58, wherein a number N of context memories is predetermined.

75. The multithread processor according to claim 58, wherein the at least one context memory comprises N context memories, each corresponding to one of the plurality of threads, each including a program counting register, a register bank, and a status register, and wherein memory contents of the program counting register, memory contents of the register bank and memory contents of the status register indicate a context of the corresponding thread.

76. The multithread processor according to claim 73, further comprising an instruction fetch unit that is operably connected to a program instruction memory in order to read a program instructions, and wherein the program counting register is operable to provide an address for the program instruction to the program instruction memory.

77. The multithread processor according to claim 53, wherein the standard processor unit is operable to provide processed data to a data bus.

78. The multithread processor according to claim 61, wherein the standard processor unit is further operable to process the sequence of the program instructions using a pipeline method.

79. The multithread processor according to claim 53, wherein the standard processor unit is operable to process a program instruction to be processed within a predetermined number of clock cycles.

80. The multithread processor according to claim 61, wherein the thread monitoring unit and the switching detector are configured to receive event control signals.

81. The multithread processor according to claim 80, wherein the event control signals include event control signals generated internal to the multithread processor and event control signals generated external to the multithread processor.

82. The multithread processor according to claim 80, wherein the standard processor unit is further operable to generate event control signals.

83. The multithread processor according to claim 82, wherein the standard processor unit is further operable to generate an event control signal corresponding to a switching program instruction.

84. The multithread processor according to claim 83, wherein the event control signal corresponding to the switching program instruction includes a switching signal element, an n-signal element and a delay path control signal element.

85. The multithread processor according to claim 84, wherein the switching detector is operable to generate the switching trigger signal based on the switching signal element.

86. The multithread processor according to claim 84, wherein the n-signal element defines a length of a delay path for the thread T_{j.}

87. The multithread processor according to claims 85, wherein the switching detector further comprises an OR gate operable to generate the switching trigger signal based on inputs from the switching signal element and the thread switching trigger data field.

88. The multithread processor according to claim 84, wherein the switching detector includes an OR gate operable to control the length of the delay path based on inputs from the thread switching data field and the n-signal element.

89. The multithread processor according to claim 84, wherein the switching detector includes an AND gate operably coupled to receive at least a portion of the thread switching data field and an inverse of the delay path control signal element.

90. The multithread processor according to claim 80, wherein the event control signals are produced by external assemblies.

91. The multithread processor according to claim 53, wherein the standard processor unit comprises at least a portion of one of a group consisting of a DSP processor, a protocol processor and a general purpose processor.

92. The multithread processor according to claim 53, wherein the standard processor unit includes an instruction execution unit, the instruction execution unit including at least one of a group consisting of an arithmetic logic unit (ALU) and an address generator unit (AGU).

93. The multithread processor according to claim 80, wherein the thread monitoring unit is configured to drive one or more switching networks as a function of the event control signals.

94. A method for switching threads T of a clocked multithread processor, the multithread processor including a standard processor unit, the method comprising:
processing a thread Tⱼ in the standard processor unit; and
switching the standard processor unit from processing the thread Tⱼ to another thread T₁, said switching responsive to reception of a first thread switching trigger data field, wherein each program instruction Iⱼₖ for a thread Tⱼ includes an associated thread switching trigger data field.

95. The method according to claim 94, further comprising the step of
fetching each program instructions Iⱼₖ for the thread Tⱼ from a program instruction memory, and wherein the step of switching further comprises, switching the thread Tⱼ from an executing state to a waiting state responsive to the first thread switching trigger data field, and holding the thread Tⱼ in the waiting state for a number of clock cycles, the number of clock cycles indicated in the first thread switching trigger data field.

96. The method according to claim 94, further comprising a step of storing at least one fetched program instruction in an extended instruction register prior to execution of the at least one fetched program instruction.

96. The method according to claim 94, further comprising temporarily storing at least one fetched program instruction in an extended instruction register.

97. The method according to claim 96, further comprising a step of sequentially executing in the standard processor unit the temporarily stored program instructions, wherein the standard processor unit is clocked by a clock signal with a predetermined clock cycle time.

98. The method according to claim 94, further comprising a step of storing two or more sets of context information, each set of context information corresponding to a thread.

99. The method according to claim 95, further comprising the steps of:
generating a switching trigger signal in a switching detector of the multithread processor responsive to the thread switching trigger data field,
generating a thread reactivation signal after the thread Tⱼ is in the waiting state for the number of clock cycles.

100. The method according to claim 99, wherein the sequence of the program instructions to be processed by the standard processor unit is controlled by a thread monitoring unit, which operates as a function of the switching trigger signal and of the thread reactivation signals such that switching takes place between threads without any clock cycle loss by the switching trigger signal.
